(19) United States
(12) Patent Application Publication
(10) Pub. No.: US 2018/0063774 A1
(43) Pub. Date: Mar. 1, 2018

(54) Utilizing Network Coverage Information to Perform Public Land Mobile Network Searches

(71) Applicant: QUALCOMM Incorporated, San Diego, CA (US)

(72) Inventors: Ajit Gupta, Hyderabad (IN); Uttam Pattanayak, San Diego, CA (US); Abhishek Bhatnagar, San Diego, CA (US); Bhanu Kiran Janga, Hyderabad (IN)

(21) Appl. No.: 15/253,987

(22) Filed: Sep. 1, 2016

(51) Int. Cl. H04W 48/16; H04B 1/3816; H04W 48/18

(52) U.S. Cl. CPC H04W 48/16; H04W 84/042; H04W 48/18; H04B 1/3816

(57) ABSTRACT

Various methods for performing public land mobile network (PLMN) searches on a mobile communication device may include obtaining information about one or more radio access technologies (RATs) for which network coverage is allowed by a network operator of a home PLMN (HPLMN) of the mobile communication device, selecting one of the one or more allowed RATs, conducting a PLMN search on the selected RAT, and determining whether there are available PLMNs on the selected RAT based on the PLMN search. In some examples, the information about one or more RATs for which network coverage is allowed by the network operator may be stored in a universal subscriber identity module (USIM) on the mobile communication device. In such example, the information may be stored in one or more PLMN selector lists on the USIM.

### BACKGROUND

Some designs of mobile communication devices—such as smart phones, tablet computers, and laptop computers—contain one or more Subscriber Identity Module (SIM) cards that provide users with access to multiple separate mobile telephony networks. Examples of radio access technologies (RATs) used by mobile telephony networks include Third Generation (3G), Fourth Generation (4G), Long Term Evolution (LTE), Time Division Multiple Access (TDMA), Code Division Multiple Access (CDMA), CDMA 2000, Wideband CDMA (WCDMA), Global System for Mobile Communications (GSM), Single-Carrier Radio Transmission Technology (1×RTT), and Universal Mobile Telecommunications Systems (UMTS). A mobile communication device may utilize a particular RAT to communicate with a network corresponding to a SIM.

A wireless communication device that includes one or more SIMs and connects to two or more separate mobile telephony networks using a shared radio frequency (RF) resource/radio may be termed a multi-SIM multi-standby (MSMS) communication device. One example of an MSMS communication device is a dual-SIM dual standby (DSDS) communication device, which includes two SIM cards supporting two subscriptions associated with different RATs sharing one RF resource. In DSDS communication devices, the separate subscriptions share the one RF resource to communicate with two separate mobile telephony networks on behalf of their respective subscriptions. When one subscription is using the RF resource, the other subscription is in stand-by mode and is not able to communicate using the RF resource.

Another type of multi-SIM mobile communication device is a multi-SIM multi-active (MSMA) device that is configured with multiple RF resources and multiple SIMs. One example of a MSMA device is a dual-SIM dual-active (DSDA) device with two RF resources and two SIMs/subscriptions. Each SIM, or subscription, may utilize one or more RF resources for communication and thus multiple subscriptions may be actively communicating at the same time.

### SUMMARY

Various examples include methods for performing public land mobile network (PLMN) searches on a mobile communication device. Various example methods may include obtaining information about one or more radio access technologies (RATs) for which network coverage is allowed by a network operator of a home PLMN (HPLMN) of a mobile communication device, selecting one of the one or more allowed RATs, conducting a PLMN search on the selected RAT, and determining whether there are available PLMNs on the selected RAT based on the PLMN search.

In some examples, the information about one or more RATs for which network coverage is allowed by the network operator may be stored in a universal subscriber identity module (USIM) on the mobile communication device. In some examples, the information about one or more RATs for which network coverage is allowed by the network operator may be stored in one or more PLMN selector lists on the USIM.

Some example methods may further include selecting an available PLMN in response to determining that there are available PLMNs on the selected RAT and acquiring service on the selected PLMN. In some examples, the available PLMN may be selected based on a priority of the available PLMNs. Some example methods may further include transmitting information about one or more RATs for which network coverage is not allowed by the network operator to the selected PLMN. Some example methods may further include obtaining information about availability of a plurality of mobile telephony services on the selected RAT, in which acquiring service on the selected PLMN may be based on the information about availability of the plurality of mobile telephony services on the selected RAT. In some examples, the information about availability of voice service and data service on the selected RAT may be stored in a USIM on the mobile communication device.

Some example methods may further include determining whether all of the one or more allowed RATs have been selected in response to determining that there are no available PLMNs on the selected RAT, selecting another one of the one or more allowed RATs in response to determining that not all of the one or more allowed RATs have been selected, and conducting a PLMN search on all RATs that the mobile communication device supports in response to determining that all of the one or more allowed RATs have been selected. In some examples, selecting one of the one or more allowed RATs may be based on a priority of each of the one or more allowed RATs. In some examples, obtaining information about the one or more RATs may be performed in response to determining that service is not available on the HPLMN.

Further examples include a mobile communication device including a memory, a universal subscriber identity module (USIM), an RF resource configured to support at least one RAT, and a processor configured to perform operations of the methods summarized above. Further examples include a non-transitory processor-readable storage medium having stored thereon processor-executable software instructions configured to cause a processor of a mobile communication device to perform operations of the methods summarized above. Further examples include a mobile communication device that includes means for performing functions of the methods summarized above.

### BRIEF DESCRIPTION OF THE DRAWINGS

The accompanying drawings, which are incorporated herein and constitute part of this specification, illustrate examples, and together with the general description and the detailed description given herein, serve to explain the features of the disclosed systems and methods.

FIG. 1 is a communication system block diagram of mobile telephony networks suitable for use with various examples.

FIG. 2 is a component block diagram of a multi-SIM mobile communication device according to various examples.

FIG. 3 is a block diagram illustrating a public land mobile network (PLMN) search according to conventional methods.

FIG. 4 is a block diagram illustrating a PLMN selector list stored in a universal SIM (SIM) on a mobile communication device according to various examples.

FIG. 5 is a block diagram illustrating encoding information about RATs for which network coverage is allowed in a Universal SIM (USIM) according to various examples.

FIG. 6 is a block diagram illustrating a public land mobile network (PLMN) search utilizing information about RATs for which network coverage is allowed according to various examples.

FIG. 7 is a process flow diagram illustrating a method for performing PLMN searches on a mobile communication device according to various examples.

FIG. 8 is a component block diagram of a mobile communication device suitable for implementing some example methods.

### DETAILED DESCRIPTION

Various examples will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

In overview, various examples include methods implemented with a processor of a mobile communication device for handling network availability on a mobile communication device configured to support at least a first subscription.

As used herein, the term “mobile communication device,” “multi-SIM mobile communication device,” or “multi-SIM device” refers to any one or all of cellular telephones, smart phones, personal or mobile multi-media players, personal data assistants, laptop computers, tablet computers, smart books, smart watches, palm-top computers, wireless electronic mail receivers, multimedia Internet-enabled cellular telephones, wireless gaming controllers, and similar personal electronic devices that includes one or more SIM cards, a programmable processor, memory, and circuitry for connecting to at least two mobile communication network with one or more shared RF resources. Various examples may be useful in mobile communication devices, such as smart phones, and so such devices are referred to in the descriptions of various examples. However, the examples may be useful in any electronic devices that may individually maintain one or more subscriptions that utilize one or more RF resources, which may include one or more of antennae, radios, transceivers, etc.

As used herein, the terms “SIM,” “USIM,” “SIM card,” “USIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a mobile communication device on a network and enable a communication service with the network. Because the information stored in a SIM/USIM enables the mobile communication device to establish a communication link for a particular communication service with a particular network, the term “subscription” is used herein as a shorthand reference to refer to the communication service associated with and enabled by the information stored in a particular SIM/USIM as the SIM/USIM and the communication network, as well as the services and subscriptions supported by that network, correlate to one another.

In order to acquire service on a subscription associated with a USIM, a mobile communication device may initiate a PLMN search for the home PLMN (HPLMN) of the USIM through a RAT. The mobile communication device may attempt to acquire service on the HPLMN through one or more RATs (e.g., 5G, 4G, or 3G). If the HPLMN is not available for service, the mobile communication device may perform a full band search for all available PLMNs in all RATs that the mobile communication device supports, and then select an available PLMN with the highest priority to acquire service. The USIM may store one or more files that specify the priority ordering of PLMNs for selecting service.

As RATs evolve into new generations or wireless protocols, such as 5G and 6G, network operators may acquire network licenses that do not encompass all RATs. For example, a network operator may provide coverage using 5G and 4G RATs, but not legacy RATs, such as 3G and 2G. Industry standards, such as the 3rd Generation Partnership Project (3GPP), do not mandate that USIMs encode information about whether the network operator allows coverage in particular RATs. Thus, even if the network operator allows coverage on certain RATs, when the HPLMN of the network operator is not available the mobile communication device will conduct a full band PLMN search on all RATs that the mobile communication device supports to prove that the HPLMN is not available in any RAT that the mobile communication device supports even if the highest priority operator preferred PLMN (OPLMN) or user preferred PLMN (UPLMN) is found before the full band PLMN search is complete. This results in unnecessary scans over RATs and a longer time to acquire service.

Similarly, network operators may have RAT-specific roaming agreements or policies. For example, a HPLMN for a USIM may be PLMN A on a 5G RAT and may have a roaming agreement with PLMN B on a 3G RAT but not with PLMN A on a 3G or 4G RAT. In this example, when the mobile communication device is roaming, the USIM may receive a registration accept with PLMN B on the 3G RAT. However, the mobile communication device may attempt a reselection to PLMN A on the 4G RAT to acquire better service. Because there is no roaming agreement with PLMN A on the 4G RAT, that reselection will fail, which wastes power and time to acquire service. The mobile communication device may also attempt redirection to PLMN B on a 4G RAT because redirection is a radio access network (RAN) feature and the RAN has no information on core network level roaming policies. This may result in unwarranted redirections that cause disruptions in service.

Another related issue is that the network operators may have domain specific roaming agreements or policies. For example, a network operator may allow voice roaming on some PLMNs, data roaming on some PLMNs, and both voice and data roaming on other PLMNs. Without information regarding such domain specific roaming agreements, a mobile communication device may attempt to register for both voice and data service on available PLMNs and receive registration rejects, which wastes power and time.

Various examples provide systems and methods implemented with a processor of a mobile communication device for performing PLMN searches on a mobile communication device that utilize information regarding allowed RATs and domain services of the network operator. By utilizing this information, the mobile communication device may acquire service more quickly by not conducting PLMN searches on RATs that are not allowed to provide network coverage by the network operator. The example methods may include obtaining information about one or more RATs for which network coverage is allowed by a network operator HPLMN of the mobile communication device (e.g., if the HPLMN is not available). This information may be stored in one or more PLMN selector lists in a USIM on the mobile communication device. The mobile communication device may select one of the allowed RATs, which may be selected based on a priority of each RAT (e.g., RATs with better service quality may have higher priority). The mobile communication device may conduct a PLMN search on the selected RAT, and determine whether there are available PLMNs on the selected RAT based on the PLMN search. If there is at least one available RAT, the mobile communication device may select an available PLMN and acquire service on the selected PLMN. The available PLMN may be selected based on a priority of the available PLMNs (e.g., based on a PLMN selector list in the USIM). The mobile communication device may also transmit information about one or more RATs for which network coverage is not allowed by the network operator to the selected PLMN so that the selected PLMN does not attempt unnecessary redirections.

The mobile communication device may also obtain information about availability of a plurality of mobile telephony services (e.g., voice service, data service, instant messaging service (IMS), broadcast service, and other services that may be enabled be future communication technologies) on the selected RAT, which may also be stored on the USIM. The mobile communication device may utilize this information to acquire allowed services on the selected PLMN and avoid consuming power and time attempting to acquire services that are not allowed. If there are no available PLMNs on the selected RAT, the mobile communication device may determine whether all of the allowed RATs have been selected, and may select another allowed RATs to conduct a PLMN search if there are still unselected allowed RATs. If there are no more unselected allowed RATs to search and no available PLMN has been found on any of the allowed RATs, the mobile communication device may conduct a PLMN search on all RATs that the mobile communication device supports.

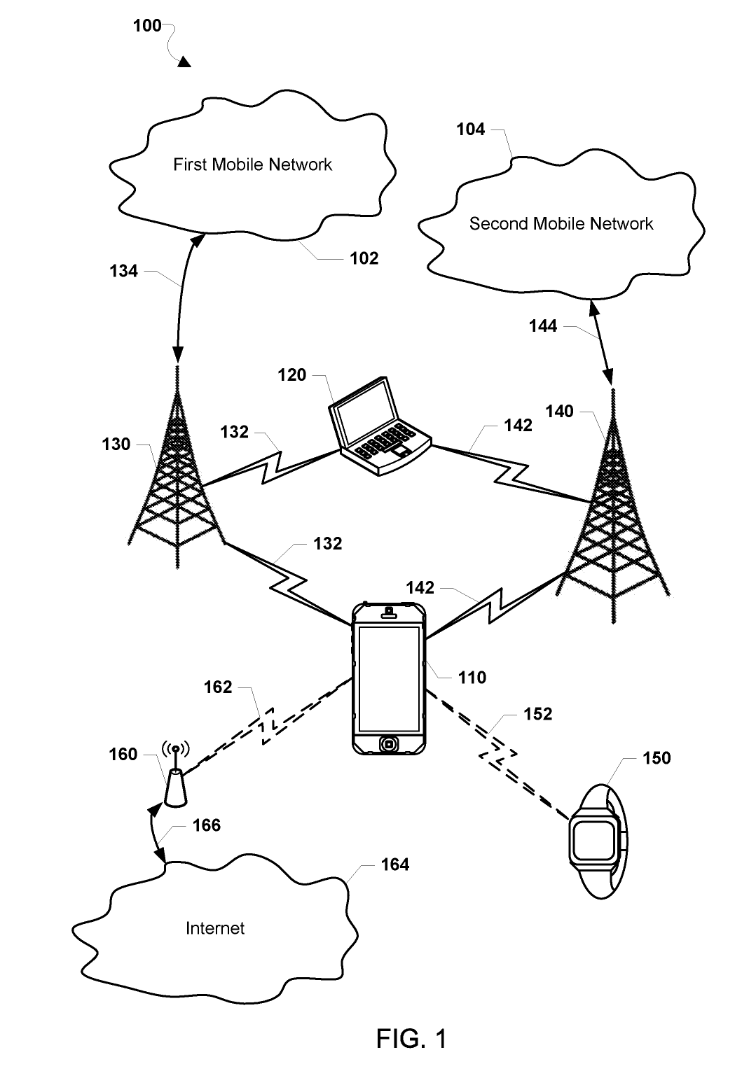

Various examples may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

While the mobile communication devices 110, 120 are shown connected to the first mobile network 102 and, optionally, to the second mobile network 104, in some examples (not shown), the mobile communication devices 110, 120 may include two or more subscriptions to two or more mobile networks and may connect to those subscriptions in a manner similar to those described herein.

In some examples, the first mobile communication device 110 may optionally establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some examples, the first mobile communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

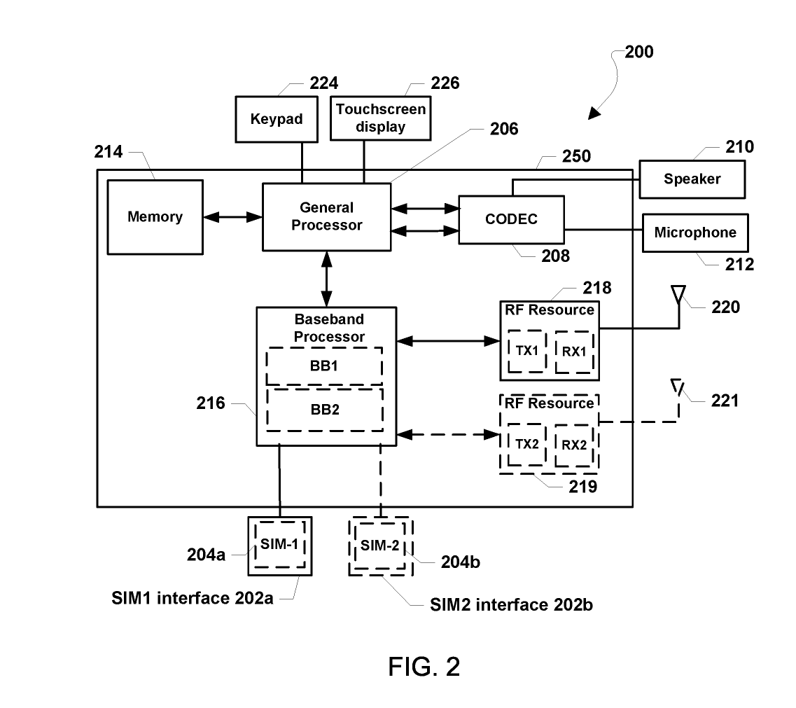

FIG. 2 is a functional block diagram of a multi-SIM mobile communication device 200 suitable for implementing various examples. With reference to FIGS. 1-2, the multi-SIM mobile communication device 200 may be similar to one or more of the mobile communication devices 110, 120 as described. The multi-SIM mobile communication device 200 may include a first SIM interface 202a, which may receive a first identity module SIM-1 204a that is associated with a first subscription. The multi-SIM mobile communication device 200 may also optionally include a second SIM interface 202b, which may receive an optional second identity module SIM-2 204b that is associated with a second subscription. In some examples, one or both of the SIMs 204a, 204b may be USIMs.

A SIM in various examples may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a central processing unit (CPU), read only memory (ROM), random access memory (RAM), electrically erasable programmable read only memory (EEPROM) and input/out (I/O) circuits.

A SIM used in various examples may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home Public Land Mobile Number (HPLMN) code, etc.) to indicate the SIM card network operator provider. An Integrated Circuit Card Identity (ICCID) SIM serial number may be printed on the SIM card for identification. However, a SIM may be implemented within a portion of memory of the multi-SIM mobile communication device 200 (e.g., in a memory 214), and thus need not be a separate or removable circuit, chip or card.

The multi-SIM mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer-readable storage medium that stores processor-executable instructions. For example, the instructions may include routing communication data relating to the first or second subscription though a corresponding baseband-RF resource chain. The memory 214 may store an operating system (OS), as well as user application software and executable instructions.

The general processor 206 and the memory 214 may each be coupled to at least one baseband modem processor 216. Each SIM and/or RAT in the multi-SIM mobile communication device 200 (e.g., the SIM-1 204a and/or the SIM-2 204b) may be associated with a baseband-RF resource chain. A baseband-RF resource chain may include the baseband modem processor 216, which may perform baseband/modem functions for communications with/controlling a RAT, and may include one or more amplifiers and radios, referred to generally herein as RF resources (e.g., RF resource 218, 219). In some examples, baseband-RF resource chains may share the baseband modem processor 216 (i.e., a single device that performs baseband/modem functions for all RATs on the multi-SIM mobile communication device 200). In other examples, each baseband-RF resource chain may include physically or logically separate baseband processors (e.g., BB1, BB2).

The RF resource 218 may be a transceiver that performs transmit/receive functions for each of the SIMs/RATs on the multi-SIM mobile communication device 200. The RF resource 218 may include separate transmit and receive circuitry, or may include a transceiver that combines transmitter and receiver functions. In some examples, the RF resource 218 may include multiple receive circuitries. The RF resource 218 may be coupled to a wireless antenna (e.g., a wireless antenna 220). The RF resource 218 may also be coupled to the baseband modem processor 216. In some optional examples, the multi-SIM mobile communication device 200 may include an optional RF resource 219 configured similarly to the RF resource 218 and coupled to an optional wireless antenna 221.

In some examples, the general processor 206, the memory 214, the baseband processor(s) 216, and the RF resources 218, 219 may be included in the multi-SIM mobile communication device 200 as a system-on-chip 250. In some examples, the first and second SIMs 204a, 204b and the corresponding interfaces 202a, 202b to each subscription may be external to the system-on-chip 250. Further, various input and output devices may be coupled to components on the system-on-chip 250, such as interfaces or controllers. Example user input components suitable for use in the multi-SIM mobile communication device 200 may include, but are not limited to, a keypad 224, a touchscreen display 226, and the microphone 212.

In some examples, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-SIM mobile communication device 200 to enable communication between them, as is known in the art.

Functioning together, the two SIMs 204a, 204b, the baseband processor BB1, BB2, the RF resources 218, 219, and the wireless antennas 220, 221 may constitute two or more radio access technologies (RATs). For example, the multi-SIM mobile communication device 200 may be a LTE communication device that includes a SIM, baseband processor, and RF resource configured to support two different RATs, such as LTE, WCDMA, and GSM. More RATs may be supported on the multi-SIM mobile communication device 200 by adding more SIM cards, SIM interfaces, RF resources, and antennae for connecting to additional mobile networks.

In some examples (not shown), the multi-SIM mobile communication device 200 may include, among other things, additional SIM cards, SIM interfaces, a plurality of RF resources associated with the additional SIM cards, and additional antennae for supporting subscriptions communications with additional mobile networks.

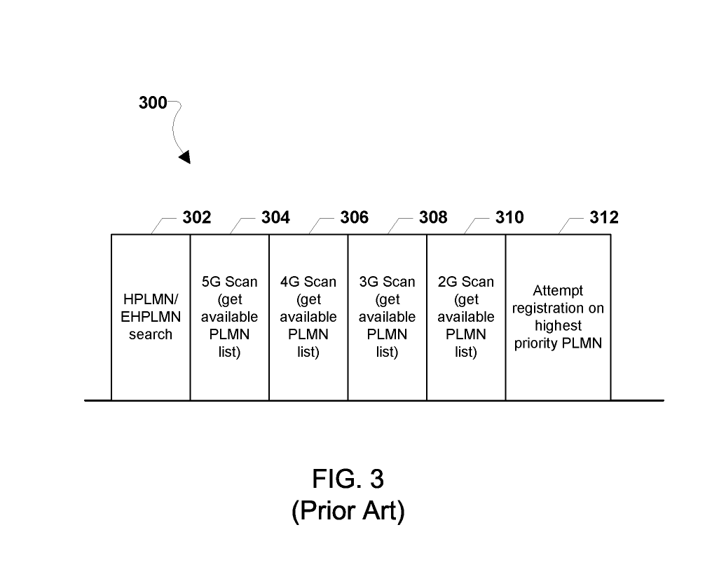

FIG. 3 includes a block diagram 300 illustrating a PLMN search on a mobile communication device according to conventional methods. The mobile communication device may include one or more USIMs that connect to mobile telephony networks of one or more network operators. Upon power up, or when recovering from out of service status, the mobile communication device may initiate a PLMN search to acquire mobile service. The PLMN search may start by searching for the HPLMN of the active USIM, or any equivalent HPLMN (EHPLMN) in block 302. The mobile communication device or USIM may store an EHPLMN list with PLMNs that are equivalent to the HPLMN.

If no HPLMN or EHPLMN is available, the mobile communication device may conduct a full band PLMN search for available PLMNs that may provide service. The mobile communication device may conduct the full band PLMN search for each RAT that the mobile communication device supports. For example, the mobile communication device may support 5G RATs, 4G RATs (e.g., LTE), 3G RATs (e.g., UTMS, CDMA, CDMA2000), and 2G RATs (e.g., GSM). The mobile communication device may sequentially conduct PLMN searches for each RAT. The order in which RATs are searched may be based on the service quality of each RAT or based on generational order. For example, higher generation RATs may be searched first because they provide higher bandwidth or better overall service quality.

As illustrated in the block diagram 300, the mobile communication device may conduct a scan on the 5G RAT(s) to obtain an available 5G PLMN list in block 304, conduct a scan on the 4G RAT(s) to obtain an available 4G PLMN list in block 306, conduct a scan on the 3G RAT(s) to obtain an available 3G PLMN list in block 308, and then conduct a scan on the 2G RAT(s) to obtain an available 2G PLMN list in block 310.

After all scans are completed, the mobile communication device may attempt registration on an available PLMN with the highest priority in block 312. The USIM may store one or more files that specify the priority ordering of PLMNs for acquiring service. For example, the USIM may store a user controlled PLMN selector list, denoted as EF_{PLMNwACT}, which specifies the priority ordering of user preferred PLMNs for acquiring service. The USIM may also store an operator controlled PLMN selector list, denoted as EF_{OPLMNwACT}, which specifies the priority ordering of network operator preferred PLMNs for acquiring service. The mobile communication device may attempt registration on an available PLMN according to the priority ordering in the user controlled PLMN selector list if it available. If the user controlled PLMN selector list is not available, the mobile communication device may attempt registration on an available PLMN according to the priority ordering in operator controlled PLMN selector list.

However, the network operator associated with the USIM may not have network licenses to use all RATs that are supported by the mobile communication device. In addition, the network operator may have roaming agreements that exclude certain RATs or service domains (e.g., voice service, data service). However, the mobile communication device conducts the full band PLMN search on all RATs supported by the mobile communication device even if the network operator does not allow use of some RATs. This may result in wasted time and power before acquiring full service.

Various examples described herein may shorten the PLMN search process by utilizing information about RATs and domain services that are allowed by the network operator. With such information, the mobile communication device may be able to ignore RATs that are not allowed by the network operator. The information about RATs and domain services that are allowed by the network operator may be stored, for example, in the USIM. Specifically, the information may be stored in the HPLMN selector list, or the operator controlled and/or user controlled PLMN selector lists.

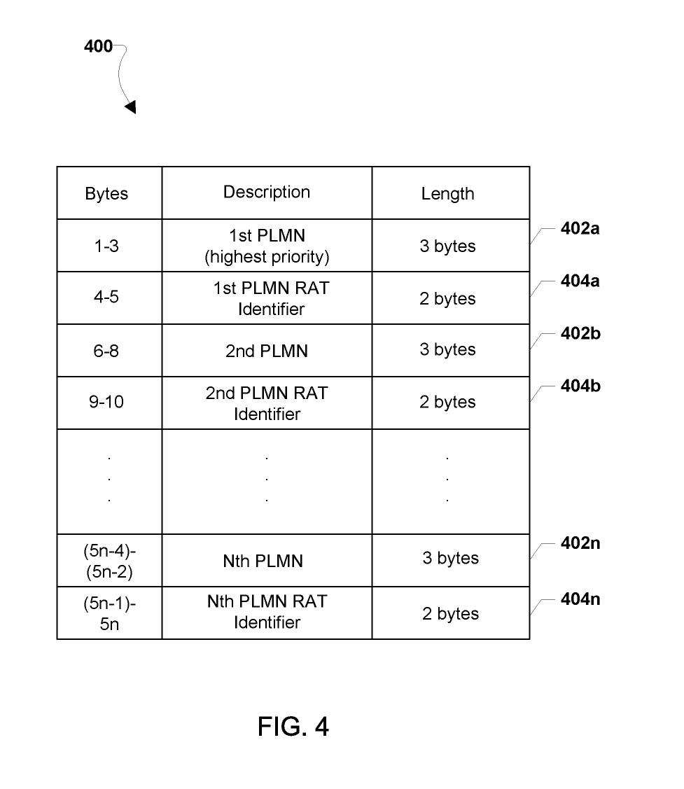

FIG. 4 illustrates a PLMN selector list 400 according to various examples. The PLMN selector list 400 may be, for example, an HPLMN selector list, an operator controlled PLMN selector list or a user controlled PLMN selector list. The PLMN selector list 400 may be stored in a USIM of a mobile communication device. The PLMN selector list 400 includes a list of PLMNs that the mobile communication device may acquire service from, listed in a priority ordering. Each PLMN entry in the PLMN selector list 400 may have a size of five bytes. The first three bytes may encode the PLMN identifier, while the last two bytes may encode the RAT identifier associated with the PLMN.

For example, the PLMN selector list 400 may store entries for n PLMNs, arranged in order from the highest priority PLMN (e.g., PLMN 1) to the lowest priority PLMN (e.g., PLMN n). The entries for each PLMN may include PLMN identifiers 402a-402n, which take up three bytes of memory, and RAT identifiers 404a-404n, which take up two bytes of memory. The RAT identifiers 404a-404n identify the RAT associated with each PLMN (e.g., 5G, 4G LTE, 3G CDMA2000, 2G GSM, etc.). Thus, the PLMN selector list 400 may take up 5n bytes of memory.

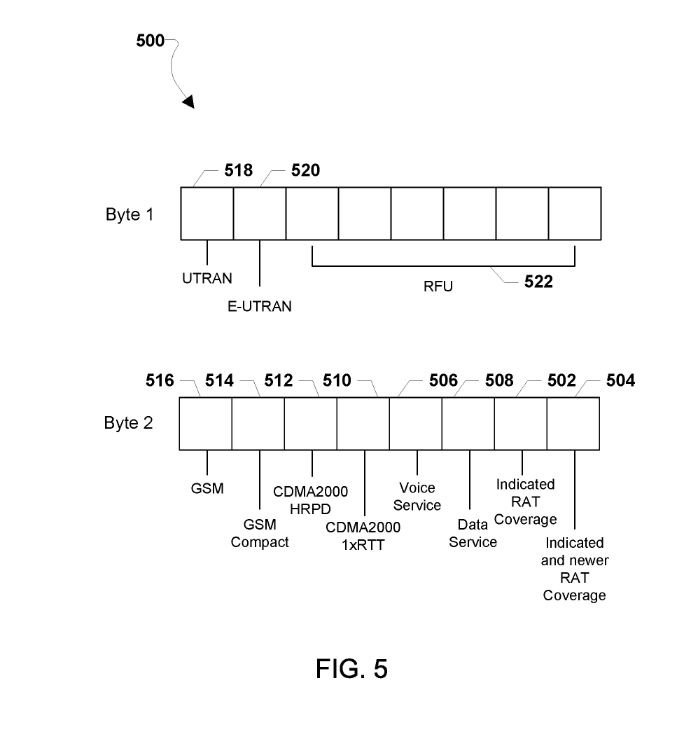

Information about RATs and domain services that are allowed by the network operator may be stored in the RAT identifier of each PLMN entry in the PLMN selector list 400. This is illustrated in FIG. 5, which shows a RAT identifier 500 in a PLMN selector list (e.g., the PLMN selector list 400). The RAT identifier 500 may take up two bytes of memory. Some of the bits within the RAT identifier may be used to indicate whether the indicated RAT is associated with the PLMN. For example, bits 510, 512, 514, 516, 518, and 520 may represent various RATs. For example, a “0” bit may indicate that the PLMN does not utilize that RAT, while a “1” bit may indicate that the PLMN utilizes that RAT. For example, if the bit 518 is 1 and the rest of the bits are 0, the RAT identifier 500 indicates that the PLMN associated with the RAT identifier 500 utilizes the UTRAN RAT.

The RAT identifier 500 may include several bits that are not utilized and reserved for future use, such as bits 522. In various examples, some of the unused bits in the RAT identifier 500 may be used to encode information about RATs that are allowed by the network operator associated with the USIM. For example, bit 502 may be a flag (i.e., either a “1” or “0” value) that indicates whether the network operator allows coverage in the indicated RAT of the RAT identifier 500. A “1” in the bit 502 indicates that the network operator allows coverage of the RAT indicated in the RAT identifier 500 (e.g., as indicated by the bits 510, 512, 514, 516, 518, and 520), while a “0” indicates that the network operator allows coverage in all RATs that the mobile communication supports.

Likewise, bit 504 may be a flag that indicates whether the network operator allows coverage in the indicated RAT of the RAT identifier 500 and all newer RATs. For example a “1” in the bit 504 indicates that the network operator allows coverage of the RAT indicated in the RAT identifier 500, plus all newer RATs (e.g., coverage of 4G as indicated by the RAT identifier 500 and newer RATs such as 5G), while a “0” in the bit 504 indicates that that the network operator allows coverage in all RATs that the mobile communication supports.

Encoding information about RATs that are allowed by the network operator in the HPLMN selector list may allow the mobile communication device to shorten the PLMN search when the HPLMN/EPLMNs are not available. By indicating the RATs that are allowed by the network operator, the mobile communication device may conduct a PLMN search on the allowed RATs rather than all RATs that the mobile communication device supports. Encoding information about RATs that are allowed by the network operator in the operator preferred PLMN selector list may allow the mobile communication device to shorten the PLMN search in roaming mode for similar reasons. Also, the information may be used to prevent the mobile communication device from reselecting to a RAT that is not allowed by the network operator after acquiring service from a PLMN and RAT that is allowed by the network operator.

Additional unused bits in the RAT identifier 500 may be used to encode information about domain services that are allowed by the network operator in each RAT. For example, bit 506 may indicate whether voice service is allowed by the network operator on the RAT indicated by the RAT identifier 500. For example, a “1” in the bit 506 may indicate that voice service is not allowed, while a “0” in the bit 506 may indicate that voice service is allowed. Likewise, bit 508 may indicate whether data service is allowed by the network operator on the RAT indicated by the RAT identifier 500. For example, a “1” in the bit 508 may indicate that data service is not allowed, while a “0” in the bit 508 may indicated that data service is allowed. Other unused bits in the RAT identifier 500 may be used to encode whether other domain services (e.g., text message service, emergency call service only, etc.) are allowed or not allowed by the network operator.

The encoding of information about RATs and domain services that are allowed by the network operator are not limited to what is shown in FIGS. 4-5. In some examples, the information indicated by the ones and zeros of the bits 502, 504, 506, and 508 may be reversed. In some examples, the information may be stored in forms other than a bit indicator flag. In some examples, the information may be stored in other portions of the PLMN selector file. In some examples, the information may be stored in other files stored in the USIM. In some examples, the information may be stored on the mobile communication device rather than the USIM.

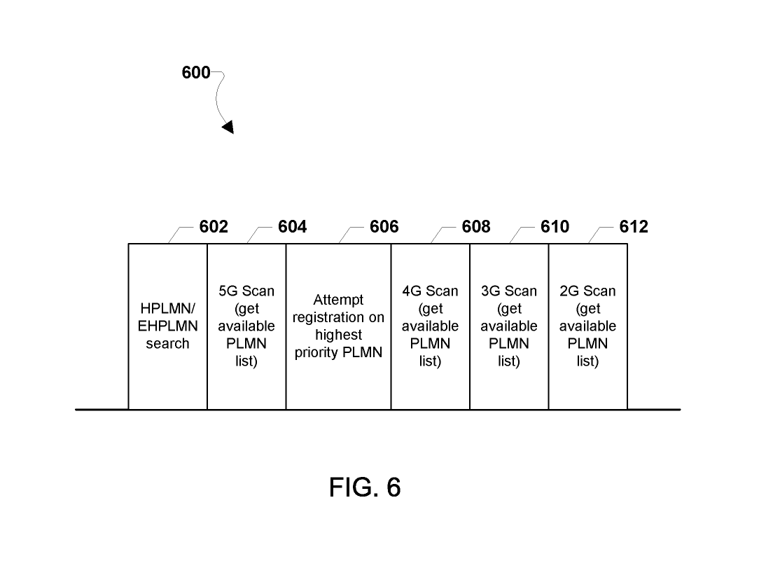

FIG. 6 includes a block diagram 600 illustrating a PLMN search on a mobile communication device utilizing information about RATs for which network coverage is allowed according to various examples. The mobile communication device may include one or more USIMs that connect to mobile telephony networks of one or more network operators. Upon power up, or when recovering from out of service status, the mobile communication device may initiate a PLMN search to acquire mobile service. The PLMN search may start by searching for the HPLMN of the active USIM, or any EHPLMN in block 602. The mobile communication device or USIM may store an EHPLMN list with PLMNs that are equivalent to the HPLMN.

If no HPLMN or EHPLMN is available, the mobile communication device may obtain information about RATs for which network coverage is allowed. This information may be encoded in one or more PLMN selector lists stored in the USIM as illustrated in FIGS. 4-5. For example, the mobile communication device may check the user controlled PLMN selector list and determine that the network operator allows coverage on 5G RATs and higher generation RATs. The mobile communication may conduct a scan on the 5G RAT(s) to obtain an available 5G PLMN list in block 604. After scanning for PLMNs on the 5G RAT(s), the mobile communication device may attempt registration on an available PLMN with the highest priority in block 606. The priority of the PLMNs may be determined by the PLMN selector list. If there is an available PLMN on the 5G RAT, the mobile communication device may acquire service from the available PLMN. This allows the mobile communication device to skip scans of the other RATs supported by the mobile communication device, which may save power and time, and result in faster service acquisition.

If there are no available PLMNs on the 5G RAT, the mobile communication device may conduct PLMN searches for the remaining RATs that the mobile communication device supports (i.e., revert to the legacy behavior as described with reference to FIG. 3). For example, the mobile communication device may conduct a scan on the 4G RAT(s) to obtain an available 4G PLMN list in block 608, then conduct a scan on the 3G RAT(s) to obtain an available 3G PLMN list in block 610, and then conduct a scan on the 2G RAT(s) to obtain an available 2G PLMN list in block 612. The mobile communication device may attempt registration on any available PLMNs on the 4G, 3G, and 2G RATs according to the priority ordering as specified in the PLMN selector list.

The information about RATs for which network coverage is allowed by the network operator may also be used to prevent unnecessary reselections or redirections during roaming. By indicating the RATs that are allowed during roaming in the operator preferred PLMN selector list, the mobile communication device may not attempt reselections to RATs that are not allowed by the network operator after roaming service is acquired. Further, once a roaming connection is established the mobile communication device may transmit information about RATs that are not allowed by the network operator to the roaming PLMN. This prevents unnecessary redirections to disallowed RATs on the network side.

The information about domain services that are allowed by the network operator may also be used to prevent unnecessary registration attempts during roaming. For example, the operator preferred PLMN selector list may indicate that data service is allowed but not voice service on a RAT that the mobile communication device is using to connect to a roaming PLMN. The mobile communication device may register for data service with the PLMN and not attempt to register for voice service based on the indicator flags, thereby preventing unnecessary registration rejections.

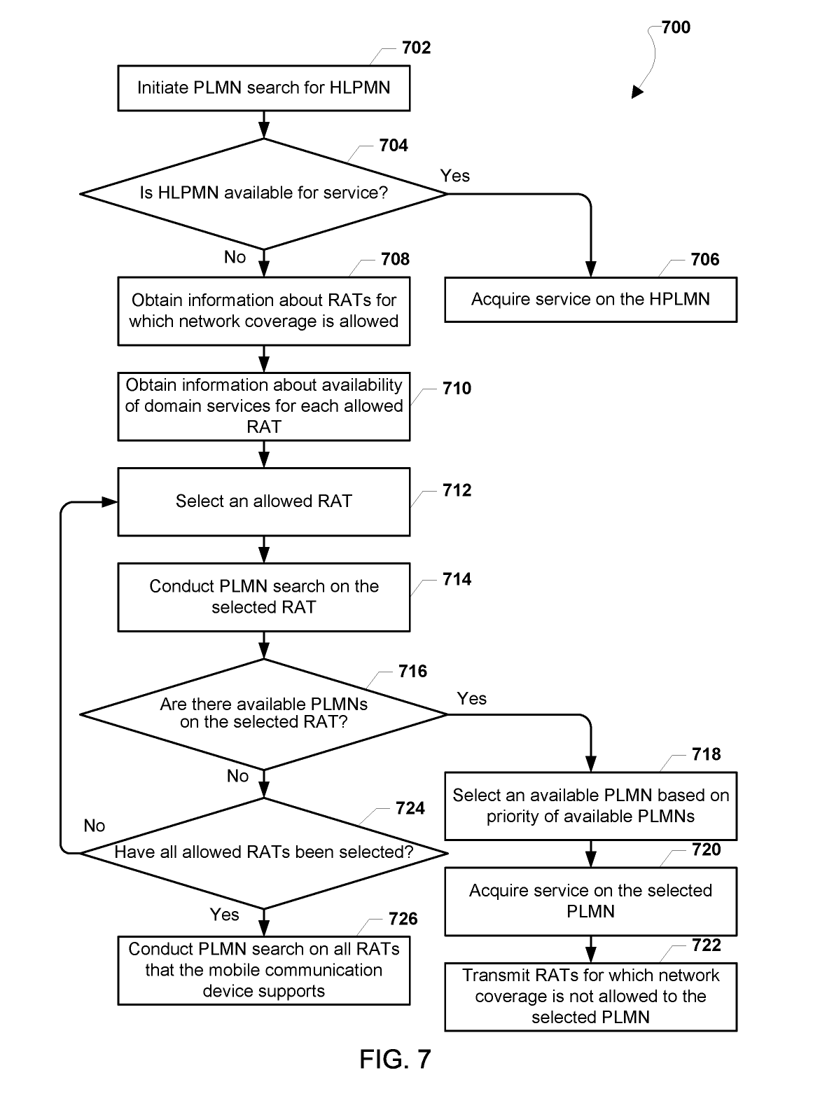

FIG. 7 illustrates a method 700 for PLMN searches on a mobile communication device according to various examples. The method 700 may be implemented with a processor (e.g., the general processor 206, the baseband modem processor 216, a separate controller, and/or the like) of a mobile communication device (such as the mobile communication devices 110, 120, 200) that supports one or more USIMs/subscriptions. For example, the mobile communication device may be a single SIM mobile device, a MSMS mobile device, or a MSMA mobile device.

In block 702, the processor may initiate a PLMN search for a HPLMN associated with a USIM on the mobile communication device. For example, the processor may initiate the PLMN search for the HPLMN upon power up of the mobile communication device, or when recovering from out of service status. The USIM or mobile communication device may store an EHPLMN list, and the processor may search for the HPLMN and any available EHPLMNs.

In determination block 704, the processor may determine whether the HPLMN (or any EHPLMN) is available. For example, the mobile communication device may determine whether it receives a signal from the HPLMN or an EHPLMN with sufficient signal strength.

In response to determining that the HPLMN (or any EHPLMN) is available (i.e., determination block 704=“Yes”), the processor may acquire service on the HPLMN (or EHPLMN) in block 706.

In response to determining that the HPLMN (and all EHPLMNs, if any) is not available (i.e., determination block 704=“No”), the processor may obtain information about RATs for which network coverage is allowed by the network operator of the HPLMN in block 708. The network operator may have network licenses or roaming agreements on certain RATs (e.g., 5G, 4G) but not other RATs (e.g., 3G, 2G). This information may be used to improve the PLMN search process on the mobile communication device. The information about RATs for which network coverage is allowed may be stored in memory of the mobile communication device (e.g., the memory 214) or in the USIM. For example, the USIM may store information about RATs for which network coverage is allowed when not in roaming in an HPLMN selector file. The USIM may also store information about RATs for which network coverage is allowed when in roaming in a user preferred PLMN selector file or an operator preferred PLMN selector file. The information may be encoded as indicator flags in the RAT identifier bytes associated with each PLMN in the PLMN selector file, such as illustrated in FIGS. 4-5. Alternatively, the information may also be stored in another file on the USIM, or in memory of the mobile communication device.

In block 710, the processor may obtain information about availability of a plurality of mobile telephony services for each RAT for which network coverage is allowed by the network operator. The network operator may have roaming agreements for voice service on certain RATs, data service on certain RATs, and both on certain RATs. In addition, there may be other domain services (e.g., IMS, broadcast, and other services that may be enabled be future communication technologies) that are allowed or not allowed by the network operator. This information may also be encoded as indicator flags in the RAT identifier bytes associated with each PLMN in the operator preferred PLMN selector file on the USIM (as illustrated in FIG. 5), or may be stored elsewhere in the USIM or the mobile communication device.

In block 712, the processor may select an allowed RAT for which network coverage is allowed by the network operator based on the obtained information. For example, the PLMN selector file on the USIM may indicate that network coverage is allowed on 5G and 4G RATs. The processor may select either the 5G or 4G RAT. The processor may select an allowed RAT based on a priority ordering. The priority ordering may be, for example, based on bandwidth or performance criteria, or based on the generational order of the RATs. For example, the processor may select the 5G RAT before the 4G RAT because the 5G RAT has better bandwidth or performance capabilities or because it is a newer generation RAT than the 4G RAT.

In block 714, the processor may conduct a PLMN search on the selected RAT. For example, if the selected RAT is a 5G RAT the processor may conduct a PLMN search on the 5G RAT for any PLMNs that are listed in the PLMN selector file(s) on the USIM.

In determination block 716, the processor may determine whether there are any available PLMNs on the selected RAT. For example, the processor may determine whether any PLMNs listed in the PLMN selector list(s) have been found.

In response to determining that there are no available PLMNs on the selected RAT (i.e., determination block 716=“No”), the processor may determine whether all RATs for which network coverage is allowed by the network operator have been selected in determination block 724.

In response to determining that not all RATs for which network coverage is allowed by the network operator have been selected (i.e., determination block 724=“No”), the processor may select another RAT for which network coverage is allowed by the network operator in block 712. In this manner, the processor may conduct PLMN searches on each RAT for which network coverage is allowed by the network operator until at least one available PLMN is found or all allowed RATs have been searched.

In response to determining that all RATs for which network coverage is allowed by the network operator have been selected (i.e., determination block 724=“Yes”), the processor may conduct a PLMN search on all RATs that the mobile communication device supports in block 726. In other words, if no PLMNs are found on RATs for which network coverage is allowed by the network operator, the processor may expand the PLMN search to all RATs that the mobile communication device supports.

In response to determining that there are available PLMNs on the selected RAT (i.e., determination block 716=“Yes”), the processor may select an available PLMN based on a priority of the available PLMNs in block 718. The priority ordering of PLMNs may be based on a PLMN selector list stored in the USIM, for example a user or operator preferred PLMN selector list.

In block 720, the processor may acquire service on the selected PLMN. In some examples, the processor may acquire domain services on the selected PLMN based on the obtained information about availability of the plurality of mobile telephony services of each RAT for which network coverage is allowed by the network operator.

In block 722, the processor may transmit a list of RATs for which network coverage is not allowed by the network operator to the selected PLMN. This information may be inferred from the obtained information about RATs for which network coverage is allowed by the network operator. Alternatively, the processor may transmit a list of RATs for which network coverage is allowed by the network operator to the selected PLMN. Sending this information may prevent the selected PLMN from attempting redirections to PLMNs on RATs for which network coverage is not allowed. This may occur in roaming situations when the selected PLMN attempts to redirect to another RAT (e.g., a higher generation RAT). In this manner, the method 700 provides a way to improve a PLMN search based on information regarding RATs that are allowed by a network operator due to various network licenses and/or roaming agreements.

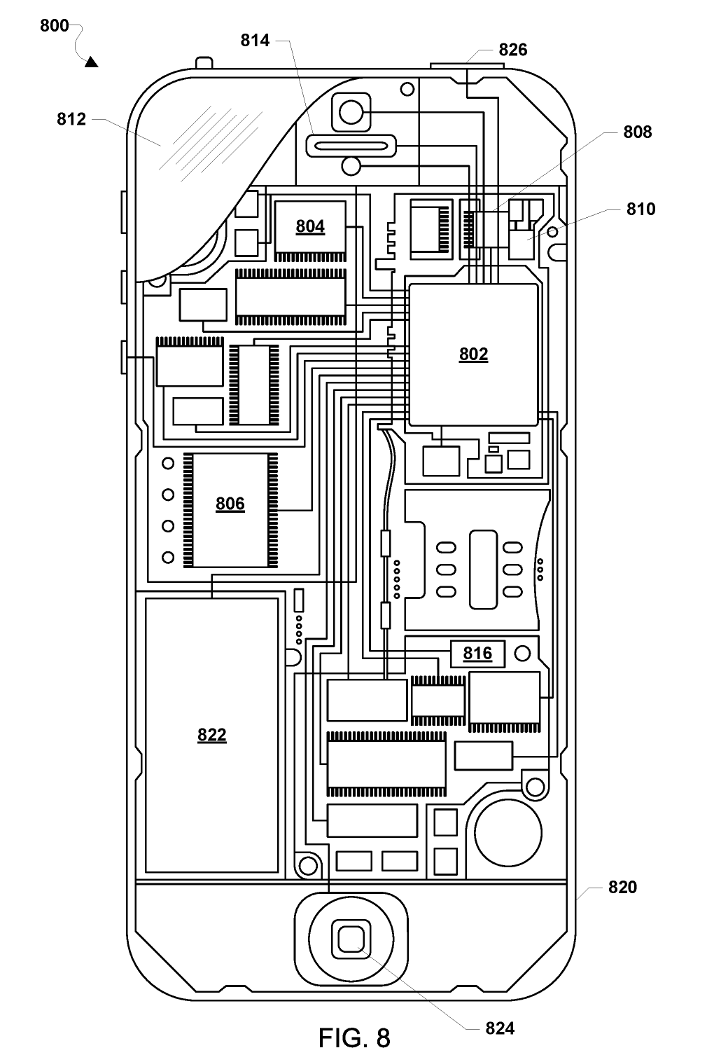

Various examples may be implemented in any of a variety of communication devices, an example of which (e.g., multi-SIM mobile communication device 800) is illustrated in FIG. 8. The multi-SIM mobile communication device 800 may be similar to the mobile communication devices 110, 120, 200, as described. As such, the multi-SIM mobile communication device 800 may implement the method 700 according to various examples.

The multi-SIM mobile communication device 800 may include a processor 802 coupled to a touchscreen controller 804 and an internal memory 806. The processor 802 may be one or more multi-core integrated circuits designated for general or specific processing tasks. The internal memory 806 may be volatile or non-volatile memory, and may also be secure and/or encrypted memory, or unsecure and/or unencrypted memory, or any combination thereof. The touchscreen controller 804 and the processor 802 may also be coupled to a touchscreen panel 812, such as a resistive-sensing touchscreen, capacitive-sensing touchscreen, infrared sensing touchscreen, etc. Additionally, the display of the multi-SIM mobile communication device 800 need not have touch screen capability.

The multi-SIM mobile communication device 800 may have one or more cellular network transceivers 808 coupled to the processor 802 and to one or more antennas 810 and configured for sending and receiving cellular communications. The one or more transceivers 808 and the one or more antennas 810 may be used with the herein-mentioned circuitry to implement various example methods. The multi-SIM mobile communication device 800 may include one or more SIM cards 816 coupled to the one or more transceivers 808 and/or the processor 802 and may be configured as described herein.

The multi-SIM mobile communication device 800 may also include speakers 814 for providing audio outputs. The multi-SIM mobile communication device 800 may also include a housing 820, constructed of a plastic, metal, or a combination of materials, for containing all or some of the components discussed herein. The multi-SIM mobile communication device 800 may include a power source 822 coupled to the processor 802, such as a disposable or rechargeable battery. The rechargeable battery may also be coupled to the peripheral device connection port to receive a charging current from a source external to the multi-SIM mobile communication device 800. The multi-SIM mobile communication device 800 may also include a physical button 824 for receiving user inputs. The multi-SIM mobile communication device 800 may also include a power button 826 for turning the multi-SIM mobile communication device 800 on and off.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the operations of various examples must be performed in the order presented. As will be appreciated by one of skill in the art the order of operations in the foregoing examples may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the examples disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present examples.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configurations. Alternatively, some operations or methods may be performed by circuitry that is specific to a given function.

In one or more example aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present examples. Various modifications to these examples will be readily apparent to those skilled in the art, and the generic principles defined herein may be applied to some examples without departing from the spirit or scope of the written description. Thus, the present disclosure is not intended to be limited to the examples shown herein but is to be accorded the widest scope consistent with the following claims and the principles and novel features disclosed herein.

What is claimed is:

1. A method for performing public land mobile network (PLMN) searches on a mobile communication device, comprising:
obtaining information about one or more radio access technologies (RATs) for which network coverage is allowed by a network operator of a home PLMN (HPLMN) of the mobile communication device;
selecting one of the one or more allowed RATs;
conducting a PLMN search on the selected RAT; and
determining whether there are available PLMNs on the selected RAT based on the PLMN search.

2. The method of claim 1, wherein the information about one or more RATs for which network coverage is allowed by the network operator is stored in a universal subscriber identity module (USIM) on the mobile communication device.

3. The method of claim 2, wherein the information about one or more RATs for which network coverage is allowed by the network operator is stored in one or more PLMN selector lists on the USIM.

4. The method of claim 1, further comprising:
selecting an available PLMN in response to determining that there are available PLMNs on the selected RAT; and
acquiring service on the selected PLMN.

5. The method of claim 4, wherein the available PLMN is selected based on a priority of the available PLMNs.

6. The method of claim 4, further comprising:
transmitting information about one or more RATs for which network coverage is not allowed by the network operator to the selected PLMN.

7. The method of claim 4, further comprising:
obtaining information about availability a plurality of mobile telephony services on the selected RAT,
wherein acquiring service on the selected PLMN is based on the information about availability of the plurality of mobile telephony services on the selected RAT.

8. The method of claim 7, wherein the information about availability of voice service and data service on the selected RAT is stored in a USIM on the mobile communication device.

9. The method of claim 1, further comprising:
determining whether all of the one or more allowed RATs have been selected in response to determining that there are no available PLMNs on the selected RAT;
selecting another one of the one or more allowed RATs in response to determining that not all of the one or more allowed RATs have been selected; and
conducting a PLMN search on all RATs that the mobile communication device supports in response to determining that all of the one or more allowed RATs have been selected.

10. The method of claim 1, wherein selecting one of the one or more allowed RATs is based on a priority of each of the one or more allowed RATs.

11. The method of claim 1, wherein obtaining information about the one or more RATs is performed in response to determining that service is not available on the HPLMN.

12. A mobile communication device, comprising:
a memory;
a universal subscriber identity module (USIM);
a radio frequency (RF) resource configured to support at least one radio access technology (RAT); and
a processor coupled to the memory, the USIM, and the RF resource, and configured to:
obtain information about one or more RATs for which network coverage is allowed by a network operator of a home public land mobile network (HPLMN) of the mobile communication device;
select one of the one or more allowed RATs;
conduct a PLMN search on the selected RAT; and
determine whether there are available PLMNs on the selected RAT based on the PLMN search.

13. The mobile communication device of claim 12, wherein the information about one or more RATs for which network coverage is allowed by the network operator is stored in the USIM.

14. The mobile communication device of claim 12, wherein the processor is further configured to:
select an available PLMN in response to determining that there are available PLMNs on the selected RAT; and
acquire service on the selected PLMN.

15. The mobile communication device of claim 14, wherein the processor is further configured to select the available PLMN based on a priority of the available PLMNs.

16. The mobile communication device of claim 14, wherein the processor is further configured to:
transmit information about one or more RATs for which network coverage is not allowed by the network operator to the selected PLMN.

17. The mobile communication device of claim 14, wherein the processor is further configured to:
obtain information about availability of a plurality of mobile telephony services on the selected RAT;
wherein the processor is further configured to acquire service on the selected PLMN based on the information about availability of the plurality of mobile telephony services on the selected RAT.

18. The mobile communication device of claim 17, wherein the information about availability of voice service and data service on the selected RAT is stored in the USIM.

19. The mobile communication device of claim 12, wherein the processor is further configured to:
determine whether all of the one or more allowed RATs have been selected in response to determining that there are no available PLMNs on the selected RAT;
select another one of the one or more allowed RATs in response to determining that not all of the one or more allowed RATs have been selected; and
conduct a PLMN search on all RATs that the mobile communication device supports in response to determining that all of the one or more allowed RATs have been selected.

20. The mobile communication device of claim 12, wherein the processor is configured to select one of the one or more allowed RATs based on a priority of each of the one or more allowed RATs.

21. The mobile communication device of claim 12, wherein the processor is configured to obtain information about the one or more RATs in response to determining that service is not available on the HPLMN.

22. A non-transitory computer readable storage medium having stored thereon processor-executable software instructions configured to cause a processor of a mobile communication device to perform operations comprising:
obtaining information about one or more radio access technologies (RATs) for which network coverage is allowed by a network operator of a home public land network (HPLMN) of the mobile communication device;
selecting one of the one or more allowed RATs;
conducting a PLMN search on the selected RAT; and
determining whether there are available PLMNs on the selected RAT based on the PLMN search.

23. The non-transitory computer readable storage medium of claim 22, wherein the information about one or more RATs for which network coverage is allowed by the network operator is stored in a universal subscriber identity module (USIM) on the mobile communication device.

24. The non-transitory computer readable storage medium of claim 22, wherein the stored processor-executable instructions are configured to cause the processor of the mobile communication device to perform operations further comprising:
selecting an available PLMN in response to determining that there are available PLMNs on the selected RAT; and
acquiring service on the selected PLMN.

25. The non-transitory computer readable storage medium of claim 24, wherein the stored processor-executable instructions are configured to cause the processor of the mobile communication device to perform operations such that the available PLMN is selected based on a priority of the available PLMNs.

26. The non-transitory computer readable storage medium of claim 24, wherein the stored processor-executable instructions are configured to cause the processor of the mobile communication device to perform operations further comprising:
transmitting information about one or more RATs for which network coverage is not allowed by the network operator to the selected PLMN.

27. The non-transitory computer readable storage medium of claim 24, wherein the stored processor-executable instructions are configured to cause the processor of the mobile communication device to perform operations further comprising:
obtaining information about availability of a plurality of mobile telephony services on the selected RAT,
wherein the stored processor-executable instructions are configured to cause the processor of the mobile communication device to perform operations such that acquiring service on the selected PLMN comprises acquiring service on the selected PLMN based on the information about availability of the plurality of mobile telephony services on the selected RAT.

28. The non-transitory computer readable storage medium of claim 22, wherein the stored processor-executable instructions are configured to cause the processor of the mobile communication device to perform operations further comprising:
determining whether all of the one or more allowed RATs have been selected in response to determining that there are no available PLMNs on the selected RAT;
selecting another one of the one or more allowed RATs in response to determining that not all of the one or more allowed RATs have been selected; and
conducting a PLMN search on all RATs that the mobile communication device supports in response to determining that all of the one or more allowed RATs have been selected.

29. The non-transitory computer readable storage medium of claim 22, wherein the stored processor-executable instructions are configured to cause the processor of the mobile communication device to perform operations such that such that selecting one of the one or more allowed RATs comprises selecting one of the one or more allowed RATs based on a priority of each of the one or more allowed RATs.

30. A mobile communication device, comprising:
means for obtaining information about one or more radio access technologies (RATs) for which network coverage is allowed by a network operator of a home public land mobile network (HPLMN) of the mobile communication device;
means for selecting one of the one or more allowed RATs;
means for conducting a PLMN search on the selected RAT; and
means for determining whether there are available PLMNs on the selected RAT based on the PLMN search.
